(19) United States
(12) Patent Application Publication
(10) Pub. No.: US 2014/0211620 A1
(43) Pub. Date: Jul. 31, 2014

(54) Method and Apparatus for Layer 2 Compression Signaling

(71) Applicant: Broadcom Corporation, Irvine, CA (US)

(72) Inventors: Keiichi KUBOTA, Weybridge (GB); Brian MARTIN, Farnham (GB); Vesa HUUMONEN, Oulu (FI)

(73) Assignee: Broadcom Corporation, Irvine, CA (US)

(21) Appl. No.: 14/168,270

(22) Filed: Jan. 30, 2014

(30) Foreign Application Priority Data
Jan. 31, 2013 (GB) 1301707.4

(51) Int. Cl. H04W 28/06

(52) U.S. Cl. CPC H04W 28/06
USPC 370/230

(57) ABSTRACT

A method for a user equipment (UE) to set up a layer 2 (L2) compression-decompression operation, comprises signaling a set of L2 compression-decompression capabilities to a serving radio network controller (RNC) or a serving base station on a uplink control channel the set of L2 compression-decompression capabilities included in a capability information element (IE) of a RRC message; receiving a set of L2 compression-decompression control parameters in a signaling message on a downlink control channel from the serving RNC or the serving base station; and configuring a local set of L2 compression-decompression control parameters based on the received set of L2 compression-decompression control parameters.

### TECHNICAL FIELD

An example embodiment of the present invention relates generally to wireless communications, and, more particularly, to layer 2 (L2) compression and decompression signaling.

### BACKGROUND

Increasing amounts of data are being carried on a new generation of wireless networks to support ever increasing numbers of applications such as video, gaming, texting in addition to traditional voice applications. A mechanism capable of reducing radio resources and thus increasing cell capacity is increasingly desirable.

Other than some compression at the application layer for some specifically selected applications, there is not a systematic scheme for applying a compression of any kind by wireless network itself. Thus a scheme for systematically applying data compression at data link layer or layer 2 of a wireless network may have a potential to substantially reduce radio source usage and thus increase the cell capacity for a wireless network.

Following abbreviations are used in this application.

| | |
|---|---|
| BS | Base Station |
| CPICH | Common Pilot Channel |
| DPCCH | Dedicated Physical Control Channel |
| E-DCH | Enhanced Data Channel |
| ECNO | Received Energy Per Chip/Power density in Band |
| EUTRAN | Enhanced UTRAN |
| HS-DPCCH | High Speed-Dedicated Physical Control Channel |
| IIR | Infinite Impulse Response |
| LTE | Long Term Evolution |
| MAC | Medium Access Control |
| PDCP | Packet Data Convergence Protocol |
| RCC | Radio Resource Control |
| RLC | Radio Link Control |
| UE | User Equipment |
| UMTS | Universal Mobile Telecommunications System |
| UTRAN | UMTS Radio Access Network |
| WCDMA | Wideband Code Division Multiple Access |

### SUMMARY

Various aspects of the invention are set out in the claims. In accordance with an example embodiment of the present invention, there is provided a method for a user equipment (UE) to set up a layer 2 (L2) compression-decompression operation, comprises signaling a set of L2 compression-decompression capabilities to a serving radio network controller (RNC) or a serving base station on a uplink control channel the set of L2 compression-decompression capabilities included in a capability information element (IE) of a RRC message; receiving a set of L2 compression-decompression control parameters in a signaling message on a downlink control channel from the serving RNC or the serving base station; and configuring a local set of L2 compression-decompression control parameters based on the received set of L2 compression-decompression control parameters.

In accordance with an example embodiment of the present invention, there is provided an apparatus for use in a user equipment to set up a L2 compression-decompression operation comprises a processing system configured to cause the apparatus to signal a set of L2 compression-decompression capabilities to a serving radio network controller (RNC) or a serving base station on a uplink control channel the set of L2 compression-decompression capabilities included in a capability information element (IE) of a RRC message; receive a set of L2 compression-decompression control parameters in a signaling message on a downlink control channel from the serving RNC or the serving base station; and configure a local set of L2 compression-decompression control parameters based on the received set of L2 compression-decompression control parameters. The processing system may be embodied by a processor and at least one memory adapted to store one or more suitably configured computer programs.

In accordance with another example embodiment of the present invention, there is provided a computer program product comprising a computer-readable medium comprising a set of instructions, which, when executed by a user equipment (UE), causes the user equipment to perform the steps of signaling a set of L2 compression-decompression capabilities to a serving radio network controller (RNC) or a serving base station on a uplink control channel the set of L2 compression-decompression capabilities included in a capability information element (IE) of a RRC message; receiving a set of L2 compression-decompression control parameters in a signaling message on a downlink control channel from the serving RNC or the serving base station; and configuring a local set of L2 compression-decompression control parameters based on the received set of L2 compression-decompression control parameters.

In accordance with another example embodiment of the present invention, there is provided a method for a serving base station to set up a layer 2 (L2) compression-decompression operation comprises receiving a first set of L2 compression-decompression capabilities from a user equipment (UE) on a uplink control channel, the set of L2 compression-decompression capabilities included in a capability information element (IE) of a RRC message; and configuring a set of L2 compression-decompression control parameters based at least on one of the received first set of L2 compression-decompression capabilities and a second set of L2 compression-decompression capabilities of the serving base station.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates an example method for L2 compression signaling at a UE in accordance with an example embodiment of the invention;

FIG. 3 illustrates an example method for L2 compression signaling at a base station in accordance with an example embodiment of the invention;

FIG. 4 illustrates an example message flow chart for L2 compression signaling in accordance with an example embodiment of the invention;

FIG. 5 illustrates an example schematic view of a layered architecture in accordance with an example embodiment of the invention;

FIG. 6 illustrates an example schematic view of MAC sublayer in accordance with an example embodiment of the invention; and

FIG. 7 illustrates an example wireless apparatus in accordance with an example embodiment of the invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. As used herein, the terms “data,” “content,” “information,” and similar terms may be used interchangeably to refer to data capable of being transmitted, received and/or stored in accordance with embodiments of the present invention. As used herein, the terms “active cell,” and “serving cell” may be used in alternative to each other to refer to a cell to which an UE is connected via a wireless connection. Likewise, as used herein, the terms “base station,” “active eNB” and “serving eNB” may be used interchangeably to refer to either a base station of a cellular network alone or a combination of a radio network controller (RNC) and a base station of a cellular network, depending on a specific wireless network context. Also as used herein, the term “compression,” and “L2 compression” and similar terms, used in a general context, may be used interchangeably to refer to both compression and decompression operations at the layer 2 of a wireless network. Thus, use of any such terms should not be taken to limit the spirit and scope of embodiments of the present invention.

Additionally, as used herein, the terms ‘circuitry’ and ‘module’ refer to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

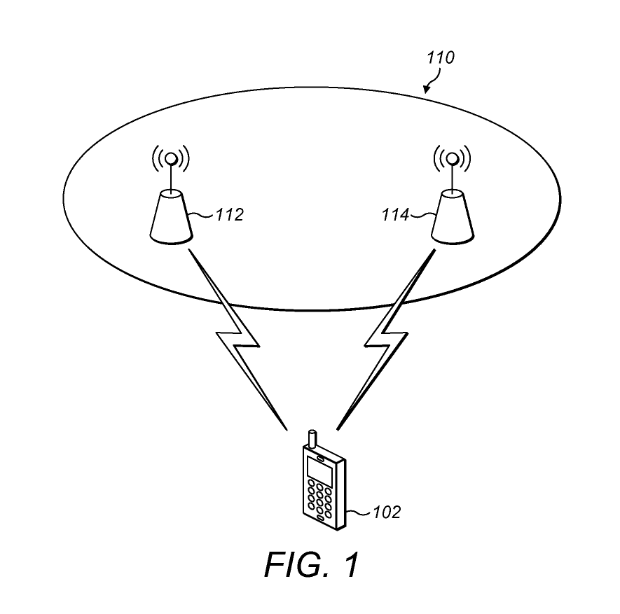

Referring now to FIG. 1, an example wireless network 100 is provided in accordance with an example embodiment of the invention. The wireless network 100 includes a UE 102, and a serving cell set 110 which in turn includes a first cell 112, and a second cell 114. In one example embodiment, the UE 102 roams into the coverage area of the cell 112 and attempts to set up a wireless connection with the serving cell. The serving cell 112, as well as the other cell 114 may be an area of WCDMA network radio coverage served by a base station Node B or LTE network radio coverage served by the base station eNB.

In one example embodiment, as the UE 102 roams into the coverage area of the serving cell set 110, the UE 102 initiates a reselection procedure to establish a connection with the serving cell 112. The UE 102 may first indicate to the serving cell 112 whether it supports L2 compression via a signaling message, along with its L2 compression capabilities included in the same or a different signaling message. The serving cell 112 may configure a set of L2 compression control parameters based on the L2 compression capabilities of the UE 102 and its own L2 compression capabilities, and may provision the configured L2 compression control parameters into the UE 102 using an signaling message. The UE 102, after receiving the L2 compression control parameters received from the serving cell 112 and set the L2 compression control parameters of its own. Then the UE 102 may confirm to the serving cell the L2 compression setup via another signaling message. From that point on, the UE 102 and the serving cell 112 may compress or decompress the data based on the configured L2 compression control parameters. In some other embodiment, there may be more than one cell involved in the data compression-decompression operations as in a HSPA scenario or a LTE network scenario in which there may be more than one cell receiving uplink data from a UE.

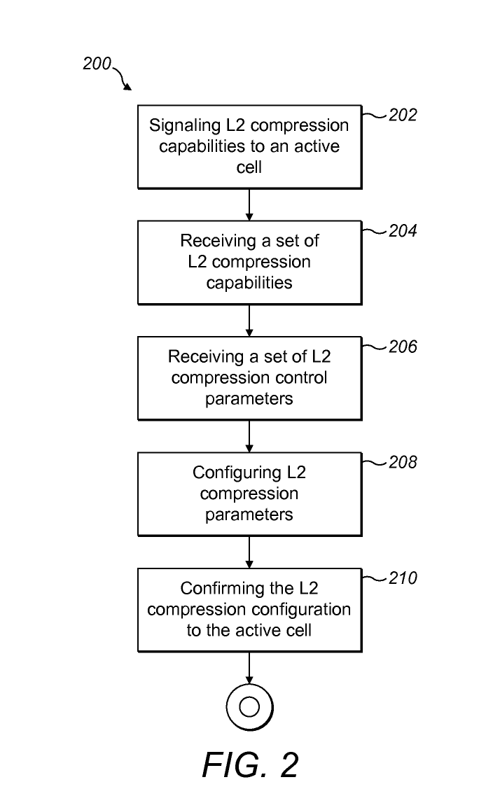

FIG. 2 illustrates an example method 200 for L2 compression signaling at a UE in accordance with an example embodiment of the invention. The method 200 may include signaling L2 compression capabilities to a serving cell at step 202, and receiving a set of L2 compression capabilities at step 204, receiving a set of L2 compression control parameters at step 206. The method 200 may also include configuring UE L2 compression control parameters at step 208 and confirming the L2 compression configuration at step 210.

In one example embodiment, signaling L2 compression capabilities to an serving cell at step 202 may include sending a RRC signaling message to the serving cell to report whether the UE supports the L2 compression and what L2 compression capabilities it supports. Signaling the L2 compression capabilities may take place at a connection establishment or during a reselection procedure. The L2 compression capabilities may include a type of L2 compression, a L2 compression direction, a L2 compression scope, one or more data types supported for L2 compression, and one or more compression algorithms appropriate for each of the supported data types, among others. The type of L2 compression may be a lossless or lossy compression and in majority of cases, a lossless compression may be used. The L2 compression scope may indicate which part of a data unit is a target for L2 compression operation, a header, a data payload, or both. The L2 compression direction may indicate a one-way or two-way compression. The one or more data types may indicate the types of data that are supported for L2 compression. L2 compression may not be applicable to some data type, either because the type of data is not suitable for compression at the layer 2 or a compression is already applied at a higher layer such as an application layer. The one or more compression algorithms indicate the compression algorithms for each of the supported data types of a compression type. For example, for a lossless L2 compression, there may be one or more generic-purpose lossless compression algorithms, one or more video data lossless compression algorithms, one or more text data lossless compression algorithms, and one or more graphic data lossless compression algorithms. Similarly, for a L2 lossy compression, there may be one or more generic-purpose lossy compression algorithms, one or more video lossy compression algorithms, one or more text lossy compression algorithms, and one or more graphic data lossy compression algorithms.

In one example embodiment, receiving a set of L2 compression capabilities at step 204 may include receiving a set of L2 compression capabilities from the serving cell. The received L2 compression capabilities may represent a L2 compression type, a L2 compression direction, a L2 compression scope, one or more L2 compression data types and the one or more compression algorithm for each data type that are supported at the serving cell.

In one example embodiment, receiving a set of L2 compression control parameters at step 206 may include receiving a set of L2 compression control parameters from the serving cell either during the connection setup or reselection procedure. The received L2 compression control parameters may include a L2 compression control flag indicating whether L2 compression is applicable for the UE. In addition, the L2 compression control parameters represent those compression parameters that are supported by both the UE and the serving serving cell. The L2 compression control parameters may include a compression type, a L2 compression direction, a L2 compression scope, one or more data types and one or more compression algorithms for each data type. In one example embodiment, the UE may receive the set of L2 compression capabilities as described above at step 204 and the set of L2 compression control parameters in a same signaling message. In another embodiment, the UE may receive the set of L2 compression capabilities and the set of L2 compression control parameters in separate signaling messages at different times.

In one example embodiment, configuring compression control parameters at step 208 may include setting the local L2 compression control parameters based on the L2 compression control parameters received from the serving cell. The UE may set its L2 compression control parameter as directed by the serving base station and copy the received L2 compression-decompression control parameters into its local memory for compression-decompression operations. In an alternative example embodiment, the UE may configure the local L2 compression control parameters as a subset of the received L2 compression control parameters. In another alternative example embodiment, the UE may determine the L2 compression control parameters locally, based on its own L2 compression capabilities, the received L2 compression capabilities of the serving cell and some UE specific circumstances. For example, the L2 compression control parameters may be a common subset of the UE's L2 compression capabilities and the received L2 compression capabilities of the serving cell. The local UE specific circumstances that may be considered may include most frequently used data type at the UE, performance criteria and local resources availability, etc.

In one example embodiment, confirming the L2 compression configuration at step 210 may include sending a signaling message to the serving cell to indicate whether L2 compression has been successfully configured and is ready for L2 compression operations. This may take place at end of connection setup or a reselection procedure.

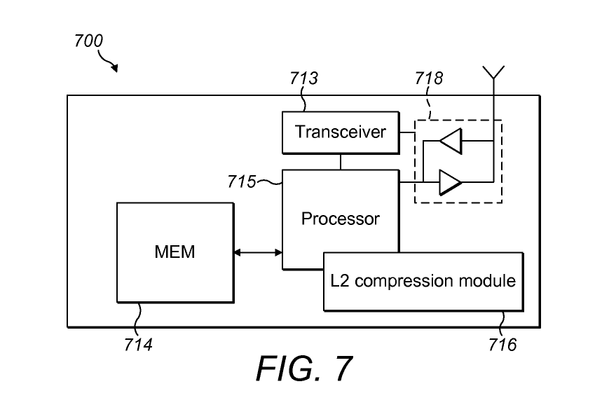

In one example embodiment, the method 200 may be implemented at the UE 102 of FIG. 1 or at the apparatus 700 of FIG. 7. The method 200 is for illustration only and the steps of the method 200 may be combined, divided, or executed in a different order than illustrated, without departing from the scope of the invention of this example embodiment.

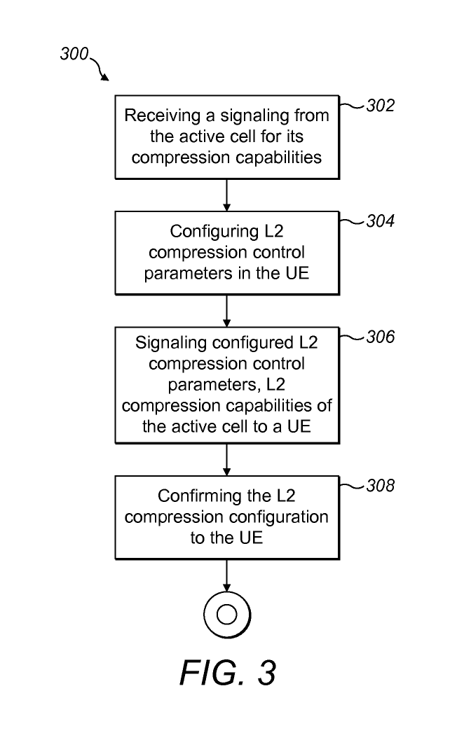

FIG. 3 illustrates an example method 300 for L2 compression signaling at a base station in accordance with an example embodiment of the invention. The method 300 may include receiving a set of L2 compression capabilities from the UE at step 302 and signaling L2 compression capabilities of the base station to a UE at step 304. The method 300 may also include configuring compression control parameters at step 306 and confirming the L2 compression configuration at step 308.

In one example embodiment, receiving a set of L2 compression capabilities from the UE at step 302 may include the set of L2 compression capabilities in a RRC signaling message from the UE at a time of connection setup or after a mobility procedure. The L2 compression capabilities may include a L2 compression type, a L2 compression direction, a L2 compression scope, one or more data types supported for L2 compression, and one or more compression algorithms appropriate for the supported data type. The definitions of the L2 compression capabilities are same as described above but the actual values of the UE's compression capabilities may be different from that of the serving cell.

In one example embodiment, configuring L2 compression control parameters at step 304 may include determining a set of L2 compression control parameters, setting a compression control flag, and provisioning the L2 compression control parameters into the UE. Determining a set of L2 compression control parameters may mainly include determining a set of compression capabilities that are common to both the UE and the serving cell. Setting a control flag may comprises setting the compression control flag to TRUE if the UE's L2 compression capabilities and the serving cell's L2 compression capabilities have at least one common compression algorithm, one common supported data type, one common associated compression algorithm, and one common compression direction. Provisioning the L2 compression control parameters into the UE may include sending the configured L2 compression control parameters to the UE in a signaling message during a connection setup or reselection procedure. In one example embodiment, configuring compression control parameters at step 306 may also include saving a local copy of the configured L2 compression control parameters at the serving cell to facilitate the L2 compression operations.

In one example embodiment, the serving cell may signal the configured L2 compression-decompression control parameters, its own L2 compression capabilities in a downlink signaling message, or both at step 306. Signaling the configured L2 compression-decompression control parameters to the UE may include sending the configured L2 compression control parameters on a downlink control channel in a RRC signaling message. In an alternative embodiment, the serving base station may signal its own L2 compression capabilities to the UE to help the UE configure its L2 compression control parameters. The signaling message may indicate whether the serving cell supports the L2 compression and what L2 compression capabilities it supports. For example, the L2 compression capabilities of the serving cell may indicate a L2 compression type, a L2 compression direction, a L2 compression scope, one or more L2 compression data types and one or more compression algorithm for each data type, that are supported at the serving cell.

In one example embodiment, confirming the L2 compression configuration at step 308 may include sending a signaling message to the UE to indicate whether L2 compression has been successfully configured at the UE and is ready for operations. This may take place at end of connection setup or a reselection procedure.

In one example embodiment, the method 300 may be implemented at the serving cell 112 of FIG. 1. The method 300 is for illustration only and the steps of the method 300 may be combined, divided, or executed in a different order than illustrated, without departing from the scope of the invention of this example embodiment.

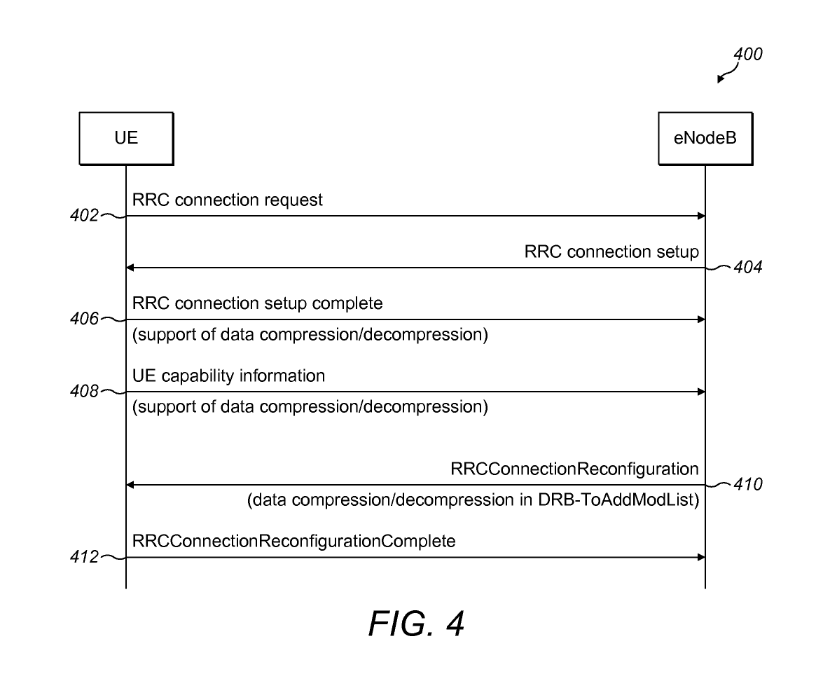

FIG. 4 illustrates an example message flow chart for signaling message exchanges between an UE and an eNB for setting up a L2 compression. In one example embodiment, the L2 compression signaling is carried on existing LTE signaling messages. The UE may initiate an connection set up by sending a RRC Connection Request at step 402 and the eNB may respond with a RRC Connection Setup message at step 404. The UE may send a RRC Connection Setup Complete message at step 406, including an indication that the UE is capable of supporting L2 compression/decompression. The eNB remembers the UE's support status for L2 compression. Then the UE may send a UE Capability Information to the eNB at step 408, the Capability Information including UE's L2 compression capabilities. Some new information element (IE) for the existing signaling protocols such as RRC may be defined for signaling L2 compression capabilities. The eNB may configure a set of L2 compression control parameters based on received UE L2 compression capabilities and its own L2 compression capabilities, set a L2 compression control flag and then provision the L2 compression control parameters into the UE via a RRC Connection Reconfiguration message at step 410. The UE may then configure its L2 compression control parameters based on the L2 compression control parameters received from the eNB and then confirm the L2 compression setup via a RRC Connection Reconfiguration Complete message to the eNB at step 412. From this point on, the UE may compress an uplink data unit and decompress a received downlink data unit based on the configured L2 compression control parameters. The eNB may compress a downlink data unit or decompress a received uplink data unit based on the same set of L2 compression control parameters.

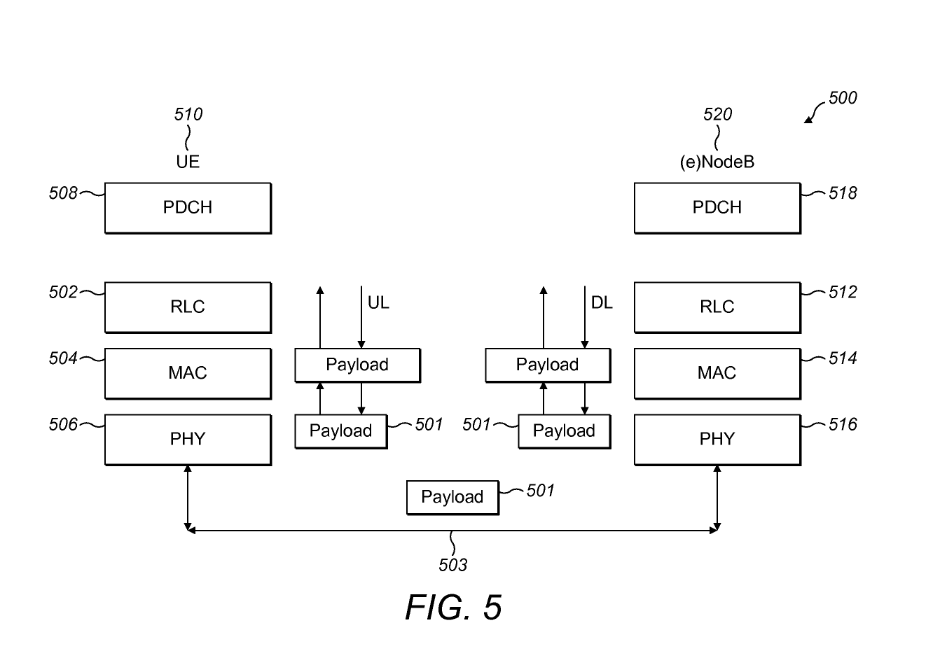

FIG. 5 shows an example schematic view of a layered architecture 500 in accordance with an example embodiment of the invention. The layered architecture 500 may include UE side 510 and the eNB side 520. The UE side 510 may include a physical (PHY) layer 506 and a data link layer, or layer 2, which in turn includes a radio link control (RLC) sublayer 502, and a media access control (MAC) sublayer 504. Above the data link layer may be a packet data convergence protocol (PDCP) sublayer 508. Similarly the eNB side 520 may includes a PDCP sublayer 518, a radio link control (RLC) sublayer 512, a media access control (MAC) sublayer 514 and a physical (PHY) layer 506. The L2 compression may be applied at PDCP sublayer, RLC sublayer or the MAC sublayer. In an example embodiment, in the downlink (DL) direction, a L2 compression is applied at the MAC sublayer 514, which may compress the payload transport block 501 before the payload 501 is passed to the PHY layer 516 for transmission over the wireless connection 503. On the UE side 510, a L2 compression module at the MAC sublayer 504 may decompresses the payload 501 to reconstruct original information before it is passed to the RLC sublayer 502 and beyond. In the uplink direction, the L2 compression module at the MAC sublayer 504 may compress another payload transport block 501 before it is given to the UE PHY layer 506 for transmission over wireless connection 503. The L2 compression module at the eNB MAC sublayer 514 may decompress the payload 501 to reconstruct original information, before the reconstructed data is passed to the eNB's RLC sublayer 512 and beyond. Because the payload data 501 is compressed before it is transmitted over the wireless connection 503, less radio resources is needed and overall system capacity may be increased.

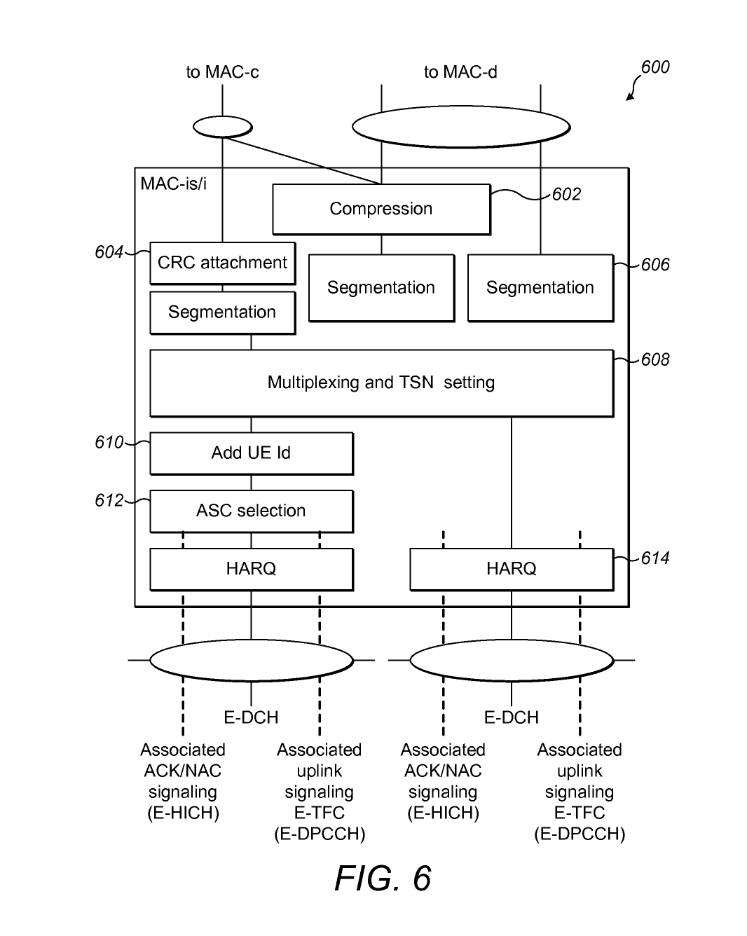

FIG. 6 illustrates an example MAC sublayer 600 of an UE in accordance with an example embodiment of the invention. In one example embodiment, a data unit is passed down to the MAC sublayer 600. Instead of directly passing the data to the cyclic redundancy check (CRC) attachment module 604 for error checking or to the segmentation module 606 for data segmentation in preparation for transmission, as in legacy operations, the data may be passed to the compression module 602 for L2 compression and the compressed data may then be passed to the segmentation module 606. Then the compressed and segmented data is multiplexed and a transmission sequence number (TSN) is added to the multiplexed data at a multiplexing & TSN setting module 608. A UE identifier may be added to the multiplexed data at block 610 and an access service class (ASC) selected for the multiplexed data at block 612. Adding UE identifier to and selecting ASC for the multiplexed data may not be needed for radio bearer data in some cases. The data is processed at a hybrid automatic repeat request (HARQ) module 614 before it is passed to an enhanced data channel (E-DCH) for transmission over an air interface to a serving mobile station. The HARQ entity 614 may be responsible for handling the HARQ protocol. There may be one HARQ process per E-DCH per transmission time interval (TTI) for a single stream transmission and two HARQ processes per E-DCH per TTI for a dual-stream transmission or a dual-cell HSUPA operation. There may be one HARQ entity per E-DCH for frequency division duplex (FDD). The HARQ functional entity may handle all the tasks that are required for hybrid ARQ. It may be for example responsible for generating ACKs or NACKs.

FIG. 7 illustrates an example wireless apparatus in accordance with an example embodiment of the invention. In FIG. 7, the wireless apparatus 700 may include a processor 715, a memory 714 coupled to the processor 715, and a suitable transceiver 713 (having a transmitter (TX) and a receiver (RX)) coupled to the processor 715, coupled to an antenna unit 718 and a L2 compression module 716. The memory 714 may store programs such as the L2 compression module 716. The wireless apparatus 700 may be at least part of a generic 4th generation handset, or an LTE compatible mobile station.

The processor 715 or some other form of generic central processing unit (CPU) or special-purpose processor such as digital signal processor (DSP), may operate to control the various components of the wireless apparatus 700 in accordance with embedded software or firmware stored in memory 714 or stored in memory contained within the processor 715 itself. In some embodiment, the processor 715 may be a collection of multiple processors or multiple cores that may collectively function as a single unit. In addition to the embedded software or firmware, the processor 715 may execute other applications or application modules stored in the memory 714 or made available via wireless network communications. The application software may comprise a compiled set of machine-readable instructions that configures the processor 715 to provide the desired functionality, or the application software may be high-level software instructions to be processed by an interpreter or compiler to indirectly configure the processor 715.

In one example embodiment, the transceiver 713 is for bidirectional wireless communications with another wireless device. The transceiver 713 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 713, portions of the antenna unit 718, and an analog baseband processing unit may be combined in one or more processing units and/or application specific integrated circuits (ASICs). Parts of the transceiver may be implemented in a field-programmable gate array (FPGA) or reprogrammable software-defined radio.

As shown in FIG. 7, the wireless apparatus 700 may further include a L2 compression module 716, which may implement at least part of the L2 compression signaling method 200 as described above. The L2 compression module 716 in collaboration with other modules, may help determine whether a L2 compression is applicable to a received data unit based on a set of L2 compression control parameters. The L2 compression module 716 may help signal the UE's L2 compression capabilities to the serving cell, configure a set of L2 compression control parameters based on a set of L2 compression control parameters received from the serving cell and confirm the setup of the L2 compression via a signaling message to the serving cell. Once the L2 compression is set up, the L2 compression module 716 may start compress uplink data units and decompress received downlink data based on the configured L2 compression control parameters.

In an example embodiment, the antenna unit 718 may be provided to convert between wireless signals and electrical signals, enabling the wireless apparatus 700 to send and receive information from a cellular network or some other available wireless communications network or from a peer wireless device. In an embodiment, the antenna unit 718 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 718 may include antenna tuning and/or impedance matching components, RF power amplifiers, and/or low noise amplifiers.

In general, the various exemplary embodiments of the wireless apparatus 700 may include, but are not limited to, part of a mobile station, an access point or a wireless device such as a portable computer having wireless communication capabilities, Internet appliances permitting wireless Internet access and browsing, as well as portable units or terminals that incorporate combinations of such functions. In one embodiment, the wireless apparatus 700 may be implemented in the UE 102 of FIG. 1.

Without in any way limiting the scope, interpretation, or application of the claims appearing below, a technical effect of one or more of the example embodiments disclosed herein is reduced use of radio resources. Another technical effect of one or more of the example embodiments disclosed herein is an increase of overall wireless system capacities.

Embodiments of the present invention may be implemented in software, hardware, application logic or a combination of software, hardware and application logic. The software, application logic and/or hardware may reside on a mobile station, an access point, a user equipment or similar network device. If desired, part of the software, application logic and/or hardware may reside on access point, and part of the software, application logic and/or hardware may reside on a network element such as a base station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a mobile device, with one example of a mobile device described and depicted in FIG. 7. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method for a user equipment (UE) to set up a layer 2 (L2) compression-decompression operation, the method comprising
signaling a set of L2 compression-decompression capabilities to a serving radio network controller (RNC) or a serving base station on a uplink control channel, wherein the set of L2 compression-decompression capabilities are included in a capability information element (IE) of a RRC message;
receiving a set of L2 compression-decompression control parameters in a signaling message on a downlink control channel from the serving RNC or the serving base station; and
configuring a local set of L2 compression-decompression control parameters based on the received set of L2 compression-decompression control parameters.

2. The method of claim 1, wherein configuring the local set of L2 control parameters comprises at least one of:
setting a compression-decompression control flag as indicated in the received set of L2 compression-decompression control parameters; and
storing the received set of L2 compression-decompression control parameters locally for compression-decompression operations by the UE.

3. The method of claim 1, further comprising
receiving a reconfiguration message upon one of a wireless network changing the serving base station and the wireless network changing the serving RNC.

4. The method of claim 1, further comprising one of:
receiving a RRC Connection Re-Establishment message upon UE initiating a re-establishment procedure, the RRC Connection Re-Establishment message including at least part of the set of L2 compression-decompression control parameters if the UE is an LTE capable UE; and
receiving a cell update confirm message upon the UE initiating a cell update procedure, the cell update confirm message including at least part of the set of L2 compression-decompression control parameters if the UE is a UMTS UE.

5. The method of claim 1, further comprising confirming to the serving base station a configuration of L2 compression.

6. The method of claim 1, wherein the set of L2 compression-decompression capabilities comprises at least a compression direction, a pre-compression data amount, one or more data types supported, and a compression algorithm for each of the one or more data types supported.

7. The method of claim 1, wherein the set of L2 compression control parameters comprises at least one of:
a compression control flag,
a compression type,
a compression scope,
a compression direction,
one or more data types to which the L2 compression or decompression is applicable, and
one or more compression-decompression algorithms for each of the one or more compression data types.

8. The method of claim 7, wherein the compression type is one of a lossless compression and a lossy compression.

9. The method of claim 8, wherein the lossless compression is one of a generic-purpose lossless compression, a video lossless compression, a text lossless compression, and a graphic data lossless compression and the lossy compression is one of a generic-purpose lossy compression, a video lossy compression, a text lossy compression, and a graphic data lossy compression.

10. The method of claim 1, wherein the capability IE is part of at least one of a RRC ConnectionSetupComplete message and a UE CapabilityInformation message of a RRC protocol.

11. The method of claim 1, wherein the L2 compression-decompression operation is carried out by at least one of a software module and a hardware module of the UE and at one or more of a medium access control (MAC) sublayer, a radio link control (RLC) sublayer and a packet data convergence protocol (PDCP) sublayer.

12. An apparatus for use in a user equipment to set up a L2 compression-decompression operation, the apparatus comprising a processing system, wherein the processing system comprises a processor and at least one memory storing at least one computer program wherein the memory storing the at least one computer program is configured with the processor to cause the apparatus to:
signal a set of L2 compression-decompression capabilities to a serving radio network controller (RNC) or a serving base station on a uplink control channel, wherein the set of L2 compression-decompression capabilities are included in a capability information element (IE) of a RRC message;
receive a set of L2 compression-decompression control parameters in a signaling message on a downlink control channel from the serving RNC or the serving base station; and
configure a local set of L2 compression-decompression control parameters based on the received set of L2 compression-decompression control parameters.

13-23. (canceled)

24. A method for a serving base station to set up a layer 2 (L2) compression-decompression operation, the method comprising:
receiving a first set of L2 compression-decompression capabilities from a user equipment (UE) on a uplink control channel, the set of L2 compression-decompression capabilities included in a capability information element (IE) of a RRC message; and
configuring a set of L2 compression-decompression control parameters based at least on one of the received first set of L2 compression-decompression capabilities and a second set of L2 compression-decompression capabilities of the serving base station.

25. The method of claim 24, further comprising signaling the configured set of L2 compression-decompression capabilities to the user equipment.

26. The method of claim 24, wherein configuring the set of L2 compression-decompression control parameters comprises at least setting a compression-decompression control flag to TRUE if the first set of L2 compression-decompression capabilities and the second set of L2 compression-decompression capabilities have at least one common compression algorithm, one common supported data type, and one common compression algorithm for the one common supported data type, and one common compression direction.

27. The method of claim 24, wherein configuring the set of L2 compression-decompression control parameters comprises selecting a set of compression-decompression capabilities that are common to both the first set of L2 compression-decompression capabilities and the second set of L2 compression-decompression capabilities.

28. The method of claim 24, wherein configuring the set of L2 control parameters comprises:
storing the set of L2 compression-decompression control parameters at the serving base station for compression-decompression operations by the serving base station.

29-30. (canceled)

31. The method of claim 24, wherein one of the first set of L2 compression-decompression capabilities and the second set of L2 compression-decompression capabilities comprises at least a compression direction, a pre-compression data amount, one or more data types supported, and a compression algorithm for each of the one or more data types supported.

32. The method of claim 24, wherein the set of L2 compression-decompression control parameters comprises at least:
a compression control flag,
a compression type,
a compression scope,
a compression direction,
one or more data types to which the L2 compression or decompression is applicable, and
one or more compression algorithms for each of the one or more compression data types.

33-34. (canceled)

35. The method of claim 24, wherein the capability IE is part of at least one of a RRC ConnectionSetupComplete message and UE CapabilityInformation message of a RRC protocol.

36-50. (canceled)
